(19) United States
(12) Patent Application Publication
(10) Pub. No.: US 2026/0145158 A1
(43) Pub. Date: May 28, 2026

(54) APPLICATION OF CARBOXYLATED COVALENT ORGANIC MAGNETIC FRAMEWORK MATERIAL AS MAGNETIC SOLID-PHASE EXTRACTION ADSORBENT

(71) Applicants: SOUTH CHINA UNIVERSITY OF TECHNOLOGY, Guangzhou, Guangdong (CN); SCUT-ZHONGSHAN INSTITUTE OF MODERN INDUSTRIAL TECHNOLOGY, Zhongshan, Guangdong (CN)

(72) Inventors: Xiaoxi LI, Guangzhou (CN); Tianxing WANG, Guangzhou (CN); Wei LIU, Guangzhou (CN); Ling CHEN, Guangzhou (CN); Bing LI, Guangzhou (CN)

(73) Assignees: SOUTH CHINA UNIVERSITY OF TECHNOLOGY, Guangzhou, Guangdong (CN); SCUT-ZHONGSHAN INSTITUTE OF MODERN INDUSTRIAL TECHNOLOGY, Zhongshan, Guangdong (CN)

(21) Appl. No.: 18/707,632

(22) PCT Filed: Nov. 4, 2022
(86) PCT No.: PCT/CN2022/129761

§ 371 Date: Feb. 5, 2026

(30) Foreign Application Priority Data
Nov. 4, 2021 (CN) 202111299277.5

(51) Int. Cl. B01J 20/22; B01D 15/26; B01D 15/38; B01J 20/28; B01J 20/282; B01J 20/30

(52) U.S. Cl. CPC B01J 20/226; B01D 15/265; B01D 15/3885; B01J 20/28009; B01J 20/282; B01J 20/3085

(57) ABSTRACT

Disclosed is an application of a magnetic carboxyl-functionalized covalent organic framework composite as a magnetic solid-phase extraction adsorbent. The preparation method for this composite comprises the following steps: (1) firstly, taking dopamine hydrochloride as a coordinating stabilizer, and synthesizing surface-aminated magnetic iron oxide particles by coprecipitating iron (III) chloride and iron (II) chloride; and (2) then activating the surface-aminated magnetic iron oxide particles, and performing covalent cross-linking on the surfaces of the aminated magnetic iron oxide particles by taking 1, 3, 5-triformylphloroglucinol (Tp) and 4, 4′-diamino-biphenyl-2, 2′-dicarboxylic acid as building blocks, acting under the reversible catalytic action of acetic acid and using a solvothermal synthesis method, so as to prepare the magnetic carboxyl-functionalized covalent organic framework composite. The carboxyl-functionalized covalent organic framework prepared has a large specific surface area, a good mesoporous structure, a stable structure, large adsorption capacity, a short balance time and multiple adsorption forces, thereby significantly simplifying the sample pretreatment steps and shortening the sample processing time.

### FIELD OF THE INVENTION

The present disclosure specifically relates to a magnetic carboxyl-functionalized covalent organic framework composite and its preparation method and application thereof in analyzing and detecting heterocyclic aromatic amines in food products, which belongs to the technical field of synthesis of porous framework materials and analytical detection.

### BACKGROUND OF THE INVENTION

Contaminants from thermal processed food are hazardous substances spontaneously generated from food raw materials during processing; and for a long time, due to a lack of understanding of formation and transformation laws of chemical hazards during the processing, safety issues have been constantly arising. The severity of the situation necessitates the monitoring and analysis of an increasing variety of food types, with increasing complexity of the sample matrices. Among them, heterocyclic aromatic amines (HAAs) are a class of chemical substances with mutagenic and carcinogenic effects produced during the high-temperature and long-term cooking and processing of protein-rich foods such as meat and fish. The content of heterocyclic aromatic amines in daily diet has always been a concern, and establishing a rapid and effective detection method for HAAs becomes one of the urgent issues to be addressed.

During the analysis and detection of food samples, the sample pretreatment takes most time and is also the most complicated, which is also the most important link of the entire analysis process. Sample pretreatment is particularly important due to the complexity of most food sample matrices and low content of analytes, especially for the detection of trace compounds such as heterocyclic aromatic amines. Solid-phase extraction is currently the most widely used sample pretreatment technology, which can realize the separation, purification and enrichment of target compounds in complex sample matrices with simple operation and high extraction efficiency. In the solid-phase extraction process, the adsorbent is a key factor influencing the extraction efficiency, which directly affects the enrichment effect of the target object. At present, the common adsorbents for solid-phase extraction mainly include inorganic solid materials represented by activated carbon, organic polymer resins represented by polystyrene-divinylbenzene polymers and ionic bonded silica gel represented by C18. These adsorbents have advantages of strong adsorption, high chemical stability, low detection limit and good mechanical strength, so that the adsorbents develop rapidly in the field of solid-phase extraction. However, after long-term application in detection, it is found that these common adsorbents have disadvantages of low recovery rate, containing monomer impurities, narrow pH application range and the like. At the same time, the solid-phase extraction technology based on the traditional adsorbents also has the shortcomings such as time consuming, large consumption of solvent, insufficient adsorption capacity, single mode of extraction force, and need for multi-stage solid-phase extraction in series. Therefore, the development of new solid-phase extraction adsorbents with high efficiency, sensitivity and selectivity for efficient enrichment of target objects in the pretreatment of food samples may have a good prospect of industrialized application and important social significance.

Currently, the most commonly used pretreatment method for samples containing heterocyclic aromatic amines was proposed by Gross et al. It mainly involves three stages: alkalization and homogenization of samples, extraction with a mixture of adsorbents such as diatomaceous earth, blue cotton and organic reagents such as ethyl acetate and dichloromethane, and purification and separation of the extracted heterocyclic aromatic amines by cation exchange with PRS columns and Bond Elut C18 columns in series. A specific process is as follows: a small amount of to-be-analyzed sample (3 to 5 g) and 12 mL of 1M sodium hydroxide are mixed and subjected to ice-bath homogenization for 3 min, then homogenate and a proper amount of diatomaceous earth are fully mixed, and then transferred into an Extrelut column. A Bond Elut PRS silica gel column is activated with 4 mL of dichloromethane containing 5% methylbenzene, and then cascaded with a column with a mixture of to-be-detected sample and diatomaceous earth. Heterocyclic aromatic amines are eluted into the PRS column from the diatomaceous earth column by using 60 mL of dichloromethane containing 5% methylbenzene. After all eluent passes through the PRS column, the eluent is pumped under negative pressure for 5 min then activated by using 6 mL of 0.1M hydrochloric acid at a flow rate of 1-2 mL/min, and then eluted by using 15 mL of mixed solution of methanol and 0.1M hydrochloric acid and 2 mL of water. Finally, strong aqua ammonia, 20% methanol aqueous solution and 0.5M ammonium acetate solution are used for desorption, and a proper amount of mixed solution of methanol and aqua ammonia is used for elution, and then the sample is loaded for analysis. The process takes a long time, and consumes vast solvent, and the multi-step purification way is complicated in operation and easy to cause the loss of target objects.

Covalent organic frameworks (COFs) are porous organic crystalline polymers formed by connecting organic building blocks through covalent bonds. Compared with the traditional solid-phase extraction adsorbents, COFs have higher structural controllability and functional modification, highly ordered rigid porous structure, light weight, low density, good crystallinity, large specific surface area and high thermal and chemical stability, and have good application prospects in the fields of gas storage and adsorption, photoelectricity, catalysis and the like. COF-TpBD is a two-dimensional imine crystal material formed by aldimine condensation reaction of 1, 3, 5-triformylphloroglucinol (Tp) and benzidine, which has large specific surface area, and has a pore size between micropores and mesopores; and moreover, a special rigid organic topological structure of TpBD endows this material with strong hydrophobic interaction, π-π conjugation, hydrogen bonding and weak cation exchange, so that TpBD may be used for adsorption and separation of various target substances. However, TpBD still has defects of low adsorption selectivity and low specific adsorption for the enrichment and detection of contaminants from thermal processed foods. Meanwhile, these contaminants in common thermal processed food often do not exist in a single form, but are generated by multiple elements and exist at the same time. Due to great differences in molecular weight, molecular polarity, stability, solubility and other physicochemical properties of these multiple hazardous substances, and relatively single extraction force mode of the traditional solid-phase extractant, great difficulties are brought to the simultaneous enrichment and separation of these multiple hazardous substances.

### SUMMARY OF THE INVENTION

In order to overcome shortcomings and disadvantages of the prior art, a first purpose of the present disclosure is to provide a magnetic carboxyl-functionalized covalent organic framework composite, which can rapidly, efficiently and selectively enrich and detect organic cancerogenic substances mainly containing heterocyclic aromatic amines in food matrices, and greatly reduce the pretreatment time and steps of samples, and also reduce the loss of target objects at the pretreatment stage of the samples.

The purpose of the present disclosure is implemented by the following technical solutions:

Application of a magnetic carboxyl-functionalized covalent organic framework composite as a magnetic solid-phase extraction adsorbent is provided, and a preparation method of this magnetic carboxyl-functionalized covalent organic framework composite includes the following steps:
(1) firstly, taking dopamine hydrochloride as a coordinating stabilizer, and synthesizing surface-aminated magnetic iron oxide particles by co-precipitating iron (III) chloride and iron (II) chloride; and
(2) activating the surface-aminated magnetic iron oxide particles by using ligand 1, 3, 5-triformylphloroglucinol (Tp), and performing covalent cross-linking on surfaces of the aminated magnetic iron oxide particles by taking 1, 3, 5-triformylphloroglucinol (Tp) and 4, 4′-diamino-biphenyl-2, 2′-dicarboxylic acid as building blocks in a solvothermal synthesis under a reversible catalytic action of acetic acid to prepare the magnetic carboxyl-functionalized covalent organic framework composite Fe₃O₄@DOPA-TpBD-(COOH)₂, and a structure of this functionalized covalent organic framework composite is as follows:

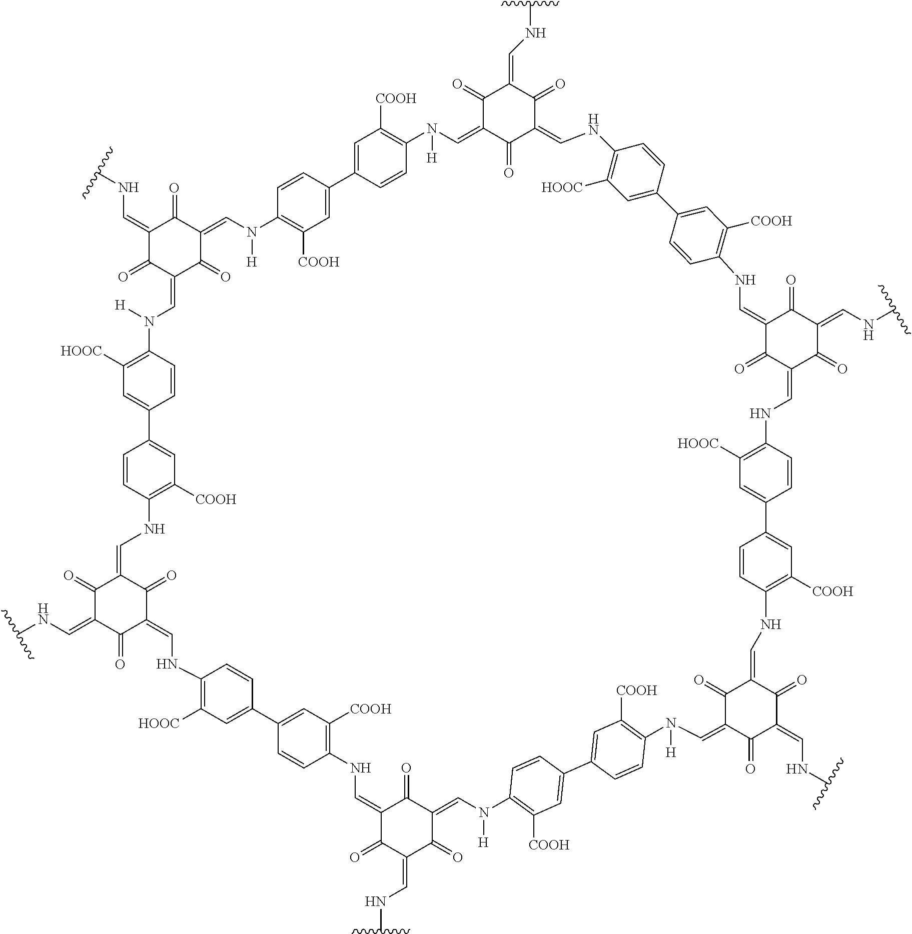 [SMILES: *N/C=C1\C(=O)/C2=C/Nc3ccc(cc3C(=O)O)-c3ccc(c(C(=O)O)c3)N/C=C3\C(=O)/C(=C/N*)C(=O)/C(=C/Nc4ccc(cc4C(=O)O)-c4ccc(c(C(=O)O)c4)N/C=C4\C(=O)/C(=C/N*)C(=O)/C(=C/Nc5ccc(cc5C(=O)O)-c5ccc(c(C(=O)O)c5)N/C=C5\C(=O)/C(=C/N*)C(=O)/C(=C\Nc6ccc(cc6C(=O)O)-c6ccc(c(C(=O)O)c6)N/C=C6\C(=O)/C(=C/N*)C(=O)/C(=C/Nc7ccc(cc7C(=O)O)-c7ccc(c(C(=O)O)c7)N/C=C7\C(=O)/C(=C/N*)C(=O)/C(=C/Nc8ccc(cc8C(=O)O)-c8ccc(c(C(=O)O)c8)N/C=C(\C1=O)C2=O)C7=O)C6=O)C5=O)C4=O)C3=O]

An infrared spectrum of the composite has characteristic absorption peaks at ˜1565 cm⁻¹, ˜1268 cm⁻¹, and ˜1720 cm⁻¹.

Preferably, step (2) specifically includes the following steps:
a. re-dispersing the aminated magnetic iron oxide particles into water, activating the aminated magnetic iron oxide particles by adding dioxane, 1, 3, 5-triformylphloroglucinol (Tp) and glacial acetic acid, and after the reaction, separating by a magnet and repeatedly washing the activated aminated magnetic iron oxide particles; and
b. re-dispersing the activated aminated magnetic iron oxide particles into dioxane, firstly adding 1, 3, 5-triformylphloroglucinol (Tp) and 4, “-diamino-biphenyl-2,”-dicarboxylic acid, then adding mesitylene and acetic acid, ultrasonically dispersing uniformly, then performing solvothermal reaction, after the reaction, collecting solid reaction products with magnets, repeatedly washing until the washing solution is colorless, and vacuum drying to obtain the magnetic carboxyl-functionalized covalent organic framework composite.

Preferably, a mole ratio of the iron (III) chloride to iron (II) chloride in step (1) is 1 to 12.

Preferably, a mole ratio of 1, 3, 5-triformylphloroglucinol (Tp) to 4, 4′-diamino-biphenyl-2, 2′-dicarboxylic acid in step b is (1:1.5)-(1:3).

Preferably, a volume ratio of mesitylene to dioxane in step b is (1:2)-(1:9), a molar concentration of the acetic acid is 6 to 12 M, and a mole ratio of a use amount of acetic acid to 1, 3, 5-triformylphloroglucinol (Tp) is (3:1)-(20:1).

Preferably, the activation of the aminated magnetic iron oxide particles in step (2) is to fully mix reactants and seal the resulting mixture for reaction for 1±0.5 h at 120±20° C.; and the preparation of the magnetic carboxyl-functionalized covalent organic framework composite is to fully mix the reactants and seal the resulting mixture for reaction for 72±12 h at 120±20° C.

Preferably, a mole ratio of the iron (III) chloride to the iron (II) chloride in step (1) is 1 to 12.

Preferably, the application of the magnetic carboxyl-functionalized covalent organic framework composite in enriching heterocyclic aromatic amines includes the following steps:
(1) fully extracting heterocyclic aromatic amines in a food sample, and storing an obtained extraction solution at 4° C. for standby use:
(2) adding nonpolar solvent into the extraction solution to remove grease, concentrating subnatant, adding water to prepare an adsorption working solution, adding the prepared composite into the solution, and magnetically stirring; and after the adsorption, removing the adsorption working solution under the action of an external magnetic field, adding a desorption solution to re-disperse this magnetic carboxyl-functionalized covalent organic framework composite adsorbed with the heterocyclic aromatic amines, after ultrasonic desorption, concentrating the desorption solution, and redissolving with methanol; and
(3) performing HPLC-MS detection on the solution obtained in step (2).

Preferably, an extraction reagent of the heterocyclic aromatic amines in step (1) is acetonitrile and 1M sodium hydroxide solution, and a volume ratio of the two is (1:1.5)-(1:2): the nonpolar solvent in step (2) is one of n-hexane, petroleum ether and cyclohexane; and a concentration of the magnetic carboxyl-functionalized covalent organic framework composite is 0.5 to 1.5 mg/mL, and the magnetic stirring time is 1 to 120 min.

Preferably, the desorption solution in step (2) is a mixture of acetonitrile and 0.1% sodium hydroxide solution, a volume ratio of the two is (2-6): (0.1-0.3); and an ultrasonic desorption condition is ultrasonic desorption for 5±3 min at 100 W.

Preferably, liquid chromatographic conditions include: chromatographic column filler is C18 (100 mm×3 mm×2.6 μm), a mobile phase is acetonitrile and acetic acid-ammonium acetate buffer solution, and gradient solution is adopted; and mass spectrometry conditions include: an ionization mode is an electrospray ionization positive ion mode (ESI+), and a scanning mode is multi-reaction monitoring (MRM).

Preferably, the target objects adsorbed by the magnetic carboxyl-functionalized covalent organic framework composite are aminoimidazoazoarenes and amino-carbolines.

According to the present disclosure, the covalent organic framework TpBD is functionally modified and loaded onto the surface-aminated magnetic iron oxide particles, which not only can enable the material to have magnetic features so as to facilitate the recovery of samples, but also can more simply and efficiently perform selective enrichment on multiple hazardous substances in food such as heterocyclic aromatic amines containing benzene rings and amino groups. The functionalized covalent organic framework composite synthesized by the above technical solutions is structurally characterized by Fourier transform infrared spectroscopy, X-ray diffraction, nitrogen adsorption-desorption, thermogravimetric analysis and scanning electron microscopy, and results show that the functionalized covalent organic framework composite is good in crystallinity, large in specific surface area and high in thermal stability. On the basis of the adsorption forces such as hydrophobic interaction and π-π conjugation provided by the original framework structure, the successful introduction of carboxyl groups endows the prepared material with multiple action modes such as hydrogen bonding, electrostatic force and ion exchange, which can realize selective adsorption and separation of target compounds with significant features such as containing a large number of benzene rings and amino groups in food samples; and the functionalized covalent organic framework composite not only can be used for the rapid adsorption of polar heterocyclic aromatic amines represented by IQ, PhIP and MeIQx in thermally-processed food, but also for the efficient enrichment and purification of non-polar heterocyclic aromatic amines represented by Harman, Norharman and MeAαC.

Compared with the prior art, the present disclosure has the following advantages and beneficial effects:
(1) The magnetic carboxyl-functionalized covalent organic framework composite provided by the present disclosure is large in specific surface area, good in mesoporous structure, moderate in pore size, good in thermal stability, high in adsorption capacity and strong in selection adsorption.
(2) The functionalized covalent organic framework composite provided by the present disclosure has various functional groups on the framework structure such as layered benzene rings of a π-π conjugate mode, rich β-ketoenamine structure, carboxyl groups and other groups, which not only can endow the material with conventional adsorption force, but also can provide multiple cross forces such as hydrogen bonding, electrostatic force and ion exchange, so that the material can simultaneously extract the multiple hazards in thermal processed food.
(3) The magnetic carboxyl-functionalized covalent organic framework composite provided by the present disclosure has a unique advantage in the pretreatment stage of the sample such as less time consumption with the adsorption process taking only 5-10 min and without the need of inorganic adsorbents for pre-purification; and there is no need to use multi-stage solid-phase extraction columns in series during elution and no need of centrifugal operation when the eluent is separated, and just simple magnetic separation is needed, which greatly simplifies the pretreatment steps of the samples; and moreover, the magnetically-separated solid-phase extractant can be used repeatedly, which greatly aids in the qualitative and quantitative analysis of trace substances in the samples.

### BRIEF DESCRIPTION OF THE DRAWINGS

FIG. 1 is an infrared spectrogram of a carboxyl-functionalized covalent organic framework;

FIG. 2 is an X-ray diffraction pattern of the carboxyl-functionalized covalent organic framework;

FIG. 3(A) is a nitrogen adsorption-desorption curve of the carboxyl-functionalized covalent organic framework;

FIG. 3(B) is a pore size distribution diagram of the carboxyl-functionalized covalent organic framework;

FIG. 4 is a thermogravimetric curve of the carboxyl-functionalized covalent organic framework in a nitrogen atmosphere;

FIG. 5(A) is a scanning electron microscope diagram I of the carboxyl-functionalized covalent organic framework;

FIG. 5(B) is a scanning electron microscope diagram II of the carboxyl-functionalized covalent organic framework;

FIG. 6 shows adsorption efficiency of the carboxyl-functionalized covalent organic framework for 15 heterocyclic aromatic amines in a pure solvent environment;

FIG. 7 shows adsorption efficiency of the carboxyl-functionalized covalent organic framework for 15 heterocyclic aromatic amines in Chaoshan crispy chicken cookies:

FIG. 8 shows adsorption efficiency of the carboxyl-functionalized covalent organic framework for 15 heterocyclic aromatic amines in sweetheart pastries:

FIG. 9 shows adsorption efficiency of the carboxyl-functionalized covalent organic framework for 15 heterocyclic amines in cantonese mooncakes; and

FIG. 10 is a flowchart of preparation and adsorption application of the carboxyl aromatic covalent organic magnetic framework.

### DETAILED DESCRIPTION OF THE EMBODIMENTS

The present disclosure is further described in detail below in combination with embodiments and accompanying drawings, but is not limited thereto.

### Example 1 Synthesis and Selective Adsorption of a Magnetic Carboxyl-Functionalized Covalent Organic Framework Composite

1.2 g of FeCl₃·6H₂O and 0.73 g of FeCl₂·4H₂O were dissolved in 20 mL of ultra-pure water, then 2.8 mL of aqua ammonia was added, and a resulting mixture was stirred at 250 rpm for 5 min at the room temperature. 1.6 mL of dopamine hydrochloride solution was then added and stirred for 1 h at the room temperature, aminated magnetic iron oxide particles were collected by a magnet and washed with the ultra-pure water until a washing solution was neutral. The aminated magnetic iron oxide particles were subsequently dispersed into 5 mL of ultra-pure water at a concentration of 50 mg/mL, followed by the addition of 25 mL of dioxane, 10 mg of 1, 3, 5-triformylphloroglucinol (Tp), and 0.38 mL of glacial acetic acid, and the reaction was carried out at 120° C. for 1 h. The activated surface-aminated magnetic iron oxide particles were separated by the magnet, washed three times respectively with tetrahydrofuran and dioxane, and then re-dispersed into 5 mL of dioxane at a concentration of 25 mg/mL. 84 mg of 1, 3, 5-triformylphloroglucinol (Tp) and 163.4 mg of 4, 4′-diamino-biphenyl-2, 2′-dicarboxylic acid were added and uniformly mixed, followed by separate addition of 2.5 mL of mesitylene and 0.65 mL of 6M acetic acid. The above reactants were fully mixed and sealed for reaction for 72 h at 120° C. Solid reaction products were collected by the magnet and washed respectively with tetrahydrofuran and acetone until the washing solution is colorless and vacuum dried for 12 h at 120° C. to prepare the magnetic carboxyl-functionalized covalent organic framework composite.

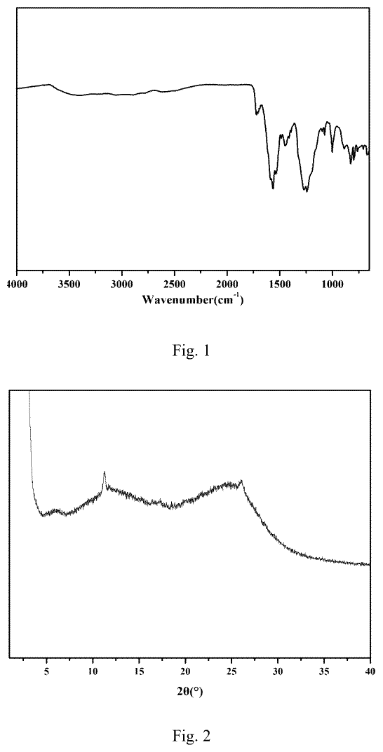

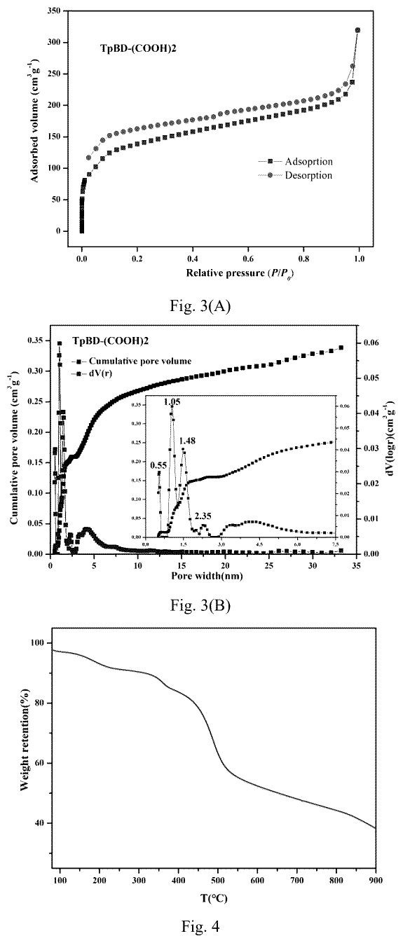

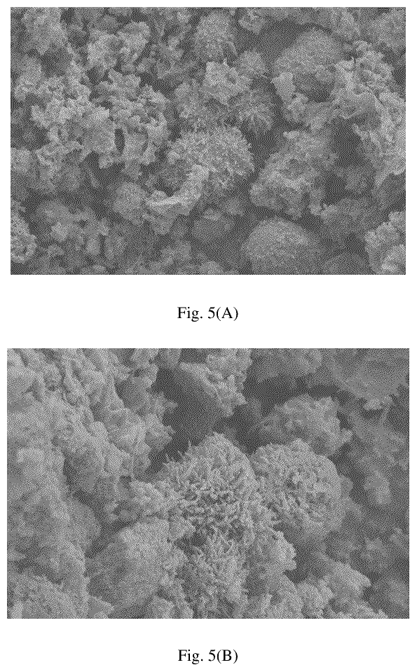

The reaction products were characterized by an infrared spectroscopy, X-ray diffraction, nitrogen adsorption-desorption, scanning electron microscope and thermogravimetric analysis. As shown in FIG. 1, a characteristic absorption peak of a C═C double bond appears at 1565 cm-1, and a characteristic stretching vibration absorption peak of a C—N bond appears at 1268 cm-1. This shows that two building blocks have Schiff base reaction and irreversible enol-ketone tautomerizm. In addition, a stretching vibration peak of a C═O double bond of carboxylic acid appears at 1720 cm-1, which indicates that the magnetic carboxyl-functionalized covalent organic framework composite is successfully synthesized. In addition, it may be seen from FIG. 3(A) that an adsorption isotherm of the reaction products shows typical IV-type features, which indicates that the reaction products have a micro-mesoporous structural feature. The specific surface area and pore volume calculated by instrument software are respectively 109.1 m²/g and 0.10 cm³/g, and an average pore size is distributed between 1.0 and 1.5 nm. A scanning electron microscope image of the magnetic carboxyl-functionalized covalent organic framework composite shows a bouquet-like structure, which may keep the structure stable at the high temperature of 350-400° C.

The adsorption selectivity and adsorption efficiency of the synthesized composite for the heterocyclic aromatic amines were evaluated by adsorption kinetic experiments. 2 mL of mixed standard solution of 15 kinds of conventional heterocyclic aromatic amines in food with a concentration of 500 μg/L was prepared, 1 mg of the material was measured and dispersed into the above mixed standard solution, followed by magnetic stirring at 300 rpm at the room temperature for 1 min, 5 min, 10 min, 20 min, 30 min, 60 min, 90 min and 120 min respectively. The adsorption solution was removed under the action of an external magnetic field, 3 mL of acetonitrile and 0.3 mL of 0.1% sodium hydroxide solution were used for re-dispersing the adsorbent, followed by ultrasonic desorption at 100 W for 5 min, and a desorption solution was concentrated and re-dissolved with chromatographic methanol. The obtained solution was filtered by a microporous filter and transferred to a sample bottle for HPLC-MS detection. Liquid chromatographic conditions: the chromatographic column was a Phenomena Kinetex column C18 (100 mm×3 mm×2.6 μm) with an injection volume of 5 μL, a column temperature of 40° C. and a flow rate of 0.3 mL/min. Mobile phase A: 2 mmol of ammonium acetate solution (containing 0.1% acetic acid); and mobile phase B: acetonitrile. Elution gradient: 0-0.5 min, 95% A, 0.5-7 min, 95%-85% A, 7-9.5 min, 85%-40% A, 9.5-9.6 min, 40%-5% A, 9.6-11 min, 5% A, 11-11.5, 5%-95% A, and 13 min, 95% A. Mass spectrometry conditions: ion source: electrospray ionization (ESI): scanning mode: multi-reaction monitoring (MRM): curtain gas: 40 psi: needle current: 3 mA: ionization temperature: 500° C.: spray voltage: 5 kV; and collision gas: medium.

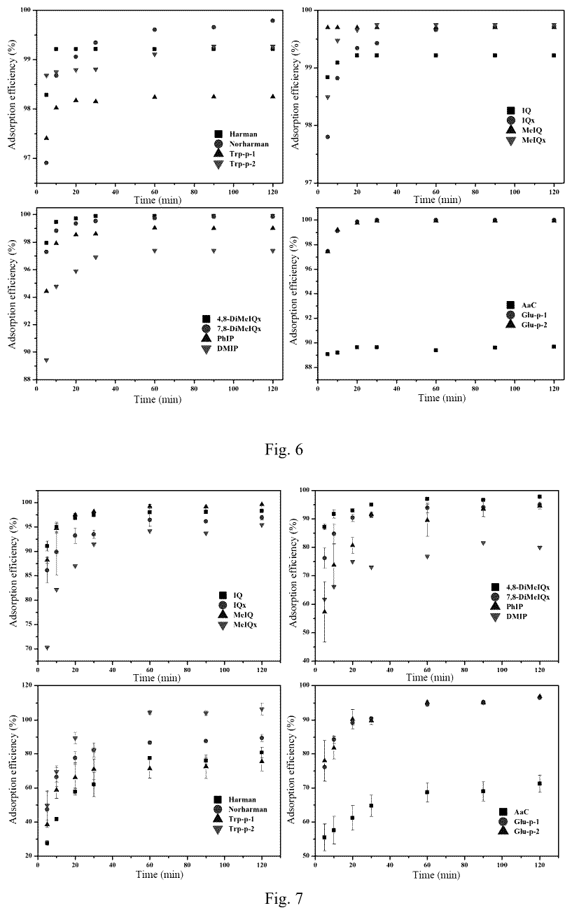

It may be from FIG. 6 that the adsorption efficiency of the prepared adsorbent for IQ-type polar heterocyclic aromatic amines at the adsorption time of 5 min is more than 98%, and is 94.4% and 89.4% respectively for two pyridine-type polar heterocyclic aromatic amines PhIP and DMIP. For the non-polar heterocyclic aromatic amines, the adsorption efficiency of the functionalized material at the adsorption time of 5 min is 89.1% for AaC, and is all more than 97% for the rest non-polar heterocyclic aromatic amines, which indicates that the prepared composite has efficient and rapid enrichment capacity for the heterocyclic aromatic amines, consumes less time, and has strong adsorption selectivity for the heterocyclic aromatic amines.

### Example 2 Adsorption Efficiency of the Magnetic Carboxyl-Functionalized Covalent Organic Framework Composite for Heterocyclic Aromatic Amines in Crispy Chicken Cookies

Commercially available Chaoshan crispy chicken cookies were crushed and mixed, and 3 g of the crushed and mixed cookies were accurately weighed and dispersed into 4 mL of acetonitrile and a heterocyclic aromatic amines spiked solution respectively and stirred uniformly, followed by the addition of 8 mL of 1M sodium hydroxide solution, homogenization for 5 min, ultrasonic extraction at 100 W for 30 min, and centrifugation at 4000 rpm for 15 min. After the homogenization was repeated twice, the supernatants were mixed. Then 5 mL of n-hexane was added into the supernatant for extraction to remove grease, subnatant was rotatably evaporated to remove acetonitrile, and the remaining solution was made up to reach 10 mL by adding distilled water, 5 mg of the material was subsequently measured and dispersed into the above solution, followed by magnetic stirring at 300 rpm at the room temperature for 1 min, 5 min, 10 min, 20 min, 30 min, 60 min, 90 min and 120 min respectively. The adsorption solution was removed under the action of an external magnetic field, 3 mL of acetonitrile and 0.3 mL of 0.1% sodium hydroxide solution were used for re-dispersing the adsorbent, followed by ultrasonic desorption at 100 W for 5 min, and a desorption solution was concentrated and re-dissolved with chromatographic methanol. The obtained solution was filtered by a microporous filter and transferred to a sample bottle for HPLC-MS detection. The liquid chromatography and mass spectrometry conditions remained the same as in Example 1. As can be seen from FIG. 7, when the adsorption time is 5 min, the adsorption efficiency of Fe₃O₄@DOPA-TpBD-(COOH)₂ for quinoline-type heterocyclic aromatic amines is more than 88%, the adsorption efficiency for IQ reaches 91%, and the quinoline heterocyclic aromatic amines for which the adsorption efficiency is the highest is 4,8-DiMeIQx (87%). For pyridine and furano-pyridine heterocyclic aromatic amines, the adsorption efficiencies of Fe₃O₄@DOPA-TpBD-(COOH)₂ for PhIP and DMIP at the adsorption time of 5 min are 57.3% and 61.7% respectively. In addition, the adsorption effect of Fe₃O₄@DOPA-TpBD-(COOH)₂ for the nonpolar heterocyclic aromatic amines at the adsorption time of 5 min is relatively low, and the adsorption efficiencies only for Glu-p-1 and Glu-p-2 are more than 76%. When the adsorption time 2 reaches h, the adsorption efficiencies of Fe₃O₄@DOPA-TpBD-(COOH)₂ for 11 heterocyclic aromatic amines except DMIP, AaC, Harman and Trp-p-1 are all more than 95%.

### Example 3 Adsorption Efficiency of the Magnetic Carboxyl-Functionalized Covalent Organic Framework Composite for Heterocyclic Aromatic Amines in Sweetheart Pastries

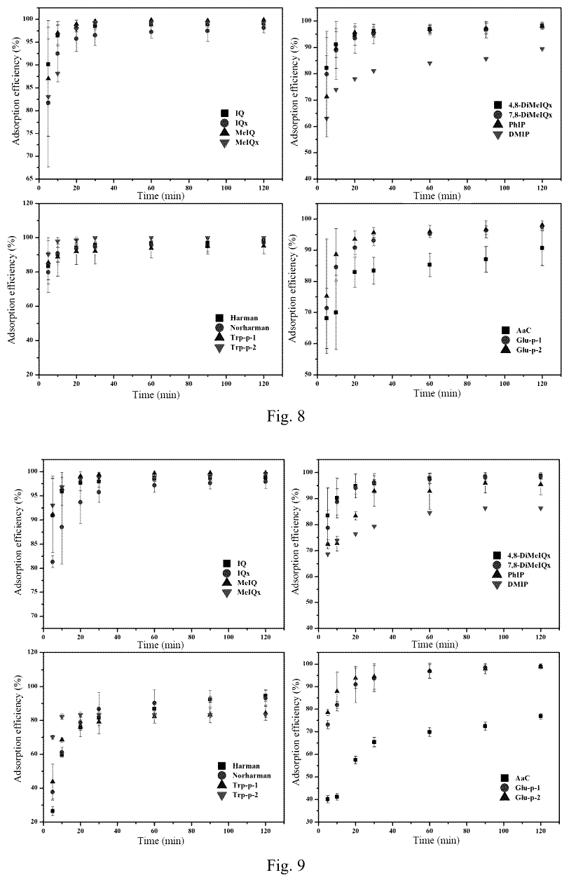

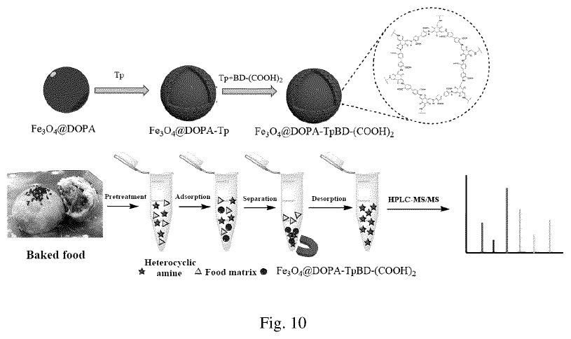

Commercially available sweetheart pastries were crushed and mixed, and 3 g of the crushed and mixed pastries were accurately weighed and dispersed into 6 mL of acetonitrile and a heterocyclic aromatic amines spiked solution respectively and stirred uniformly, followed by the addition of 7 mL of 1 M sodium hydroxide solution, homogenization for 5 min, ultrasonic extraction at 100 W for 30 min, and centrifugation at 4000 rpm for 15 min. After the homogenization was repeated twice, the supernatants were mixed. Then 5 mL of cyclohexane was added into the supernatant for extraction to remove grease, subnatant was rotatably evaporated to remove acetonitrile, the remaining solution was made up to 10 mL by adding distilled water, 5 mg of the material was subsequently measured and dispersed into the above solution, followed by magnetic stirring at 300 rpm at the room temperature for 1 min, 5 min, 10 min, 20 min, 30 min, 60 min, 90 min and 120 min respectively. The adsorption solution was removed under the action of an external magnetic field, 2 mL of acetonitrile and 0.2 mL of 0.1% sodium hydroxide solution were used for re-dispersing the adsorbent, followed by ultrasonic desorption for 8 min at 100 W. The concentrated desorption solution was redissolved with chromatographic methanol, and filtered and transferred into a sample bottle for HPLC-MS detection. The liquid chromatography and mass spectrometry conditions remained the same as in Example 1. It may be seen from FIG. 8 that the matrix environment of the sweetheart pastry has relatively little influence on the adsorption capacity of the magnetic carboxyl-functionalized covalent organic framework composite. When the adsorption time reaches 5 min, the adsorption efficiency of Fe₃O₄@DOPA-TpBD-(COOH)₂ for all 15 heterocyclic aromatic amines is more than 70%, and the adsorption efficiency especially for the quinoline-type heterocyclic aromatic amines with high abundance in baked food is more than 87%. When the adsorption time reaches 120 min, the adsorption efficiencies for 11 heterocyclic aromatic amines except DMIP (89.5%), AaC (90.6%) and Trp-p-1 (95.1%) are all more than 98%.

### Example 4 Adsorption Efficiency of the Magnetic Carboxyl-Functionalzied Covalent Organic Framework Composite for Heterocyclic Aromatic Amines in Cantonese Mooncakes

Commercially available Cantonese mooncakes were crushed and mixed, and 3 g of the crushed and mixed Cantonese mooncakes were accurately weighed and dispersed into 7 mL of acetonitrile and a heterocyclic aromatic amines spiked solution respectively and stirred uniformly, followed by the addition of 8 mL of 1M sodium hydroxide solution, homogenization for 5 min, ultrasonic extraction at 100 W for 30 min, and centrifugation at 4000 rpm for 15 min. After the homogenization was repeated twice, the supernatants were mixed. Then 5 mL of petroleum ether was added into the supernatant for extraction to remove grease, subnatant was rotatably evaporated to remove acetonitrile, the remaining solution was made up to 10 mL by adding distilled water, 5 mg of the material was subsequently measured and dispersed into the above solution, followed by magnetic stirring at 300 rpm at the room temperature for 1 min, 5 min, 10 min, 20 min, 30 min, 60 min, 90 min and 120 min respectively. The adsorption solution was removed under the action of an external magnetic field, 6 mL of acetonitrile solution and 0.3 mL of 0.1% sodium hydroxide solution were used for re-dispersing the adsorbent, followed by ultrasonic desorption at 100 W for 3 min. The concentrated desorption solution was redissolved with chromatographic methanol, and filtered and transferred into a sample bottle for HPLC-MS detection. The liquid chromatography and mass spectrometry conditions remained the same as in Example 1. It may be seen from FIG. 9 that as time increases, the adsorption efficiency increases gradually, and the adsorption efficiencies of Fe₃O₄@DOPA-TpBD-(COOH)₂ for 11 heterocyclic aromatic amines except AaC, Harman, Norharman and Trp-p-1 are all more than 70% at the adsorption time of 5 min. The adsorption efficiency for all 15 heterocyclic aromatic amines at the adsorption time of 120 min is more than 90%, and the adsorption efficiency especially for the quinoline and quinoxaline heterocyclic aromatic amines with relatively high content in common baked food is all more than 99%.

The above embodiments are preferred embodiments of the present disclosure, but the embodiments of the present disclosure are not limited by the above embodiments, and any other changes, modifications, substitutions, combinations, simplification, etc. made without departing from the spirit and principle of the present disclosure should all be equivalent replacement methods, and should all be included in the protection scope of the present disclosure.

1. Application of a magnetic carboxyl-functionalized covalent organic framework composite as a magnetic solid-phase extraction adsorbent, wherein a preparation method of the magnetic carboxyl-functionalized covalent organic framework composite comprises the following steps:
(1) firstly, taking dopamine hydrochloride as a coordinating stabilizer, and synthesizing surface-aminated magnetic iron oxide particles by co-precipitating iron (III) chloride and iron (II) chloride; and
(2) activating the surface-aminated magnetic iron oxide particles by using ligand 1, 3, 5-triformylphloroglucinol (Tp), and performing covalent cross-linking on surfaces of the aminated magnetic iron oxide particles by taking 1, 3, 5-triformylphloroglucinol (Tp) and 4, 4′-diamino-biphenyl-2, 2′-dicarboxylic acid as building blocks in a solvothermal method under a reversible catalytic action of acetic acid to prepare the magnetic carboxyl-functionalized covalent organic framework composite.

2. The application according to claim 1, wherein step (2) specifically comprises the following steps:
a. re-dispersing the aminated magnetic iron oxide particles into water, activating the aminated magnetic iron oxide particles by adding dioxane, 1, 3, 5-triformylphloroglucinol (Tp) and glacial acetic acid, and after the reaction, separating by a magnet and repeatedly washing the activated aminated magnetic iron oxide particles; and
b. re-dispersing the activated aminated magnetic iron oxide particles into dioxane, firstly adding 1, 3, 5-triformylphloroglucinol (Tp) and 4, 4′-diamino-biphenyl-2, 2′-dicarboxylic acid, then adding mesitylene and acetic acid, ultrasonically dispersing uniformly, then performing solvothermal reaction, after the reaction, collecting solid reaction products with magnets, repeatedly washing until the washing solution is colorless, and vacuum drying to obtain the magnetic carboxyl-functionalized covalent organic framework composite.

3. The application according to claim 2, wherein a mole ratio of 1, 3, 5-triformylphloroglucinol (Tp) to 4, 4′-diamino-biphenyl-2, 2′-dicarboxylic acid in step b is (1:1.5)-(1:3).

4. The application according to claim 3, wherein a volume ratio of mesitylene to dioxane in step b is (1:2)-(1:9), a molar concentration of the acetic acid is 6 to 12 M, and a mole ratio of a use amount of acetic acid to 1, 3, 5-triformylphloroglucinol (Tp) is (3:1)-(20:1).

5. The application according to claim 4, wherein the activation reaction in step a is a reaction of 1+0.5 h at 120+20° C. after reactants are fully mixed and sealed; the solvothermal reaction in step b is a reaction of 72+12 h at 120+20° C. after reactants are fully mixed and sealed; and a mole ratio of iron (III) chloride to the iron (II) chloride in step (1) is 1 to 12.

6. The application according to claim 1, wherein the application of magnetic carboxyl-functionalized covalent organic framework composite in enriching heterocyclic aromatic amines in food comprises the following steps:
(1) fully extracting heterocyclic aromatic amines in a food sample to obtain an extraction solution;
(2) adding nonpolar solvent into the extraction solution to remove grease, concentrating subnatant, adding water to prepare an adsorption working solution, adding the magnetic carboxyl-functionalized covalent organic framework composite into the solution, and magnetically stirring; and after the adsorption, removing the adsorption working solution under the action of an external magnetic field, adding a desorption solution to re-disperse the magnetic carboxyl-functionalized covalent organic framework composite adsorbed with the heterocyclic amines, after ultrasonic desorption, concentrating the desorption solution, and redissolving with methanol; and
(3) performing HPLC-MS detection on the solution obtained in step (2).

7. The application according to claim 6, wherein an extraction reagent of the heterocyclic aromatic amines in step (1) is acetonitrile and 1M sodium hydroxide solution, and a volume ratio of the two is (1:1.5)-(1:2); the nonpolar solvent in step (2) is one of n-hexane, petroleum ether and cyclohexane; and a concentration of the magnetic carboxyl-functionalized covalent organic framework composite is 0.5 to 1.5 mg/mL, and the magnetic stirring time is 1 to 120 min.

8. The application according to claim 7, wherein the desorption solution in step (2) is a mixture of acetonitrile and 0.1% sodium hydroxide solution, a volume ratio of the two is (2-6): (0.1-0.3); and an ultrasonic desorption condition is ultrasonic desorption for 5±3 min at 100 W.

9. The application according to claim 8, wherein liquid chromatographic conditions comprise: chromatographic column filler is C18, a mobile phase is acetonitrile and acetic acid-ammonium acetate buffer solution, and gradient elution is adopted; and
mass spectrometry conditions comprise: an ionization mode is an electrospray ionization positive ion mode (ESI+), and a scanning mode is multi-reaction monitoring (MRM).

10. The application according to claim 9, wherein target objects adsorbed by the magnetic carboxyl-functionalized covalent organic framework composite are aminoimidazoazoarenes and amino-carbolines.
